(19) United States
(12) Patent Application Publication
(10) Pub. No.: US 2005/0242041 A1
(43) Pub. Date: Nov. 3, 2005

(54) Silver Impregnated, Alumina Coated Materials and Filtration Systems Implementing Same

(76) Inventor: Scott L. Cumberland, Oakland, CA (US)

Correspondence Address: THE CLOROX COMPANY, 1221 BROADWAY PO BOX 2351, OAKLAND, CA, 94623, US

(21) Appl. No.: 10/837,208

(22) Filed: Apr. 30, 2004

(51) Int. Cl. C02F 1/28

(52) U.S. Cl. 210/660; 210/263; 210/501

(57) ABSTRACT

Abstract of the Disclosure

A cationically charged material suitable for use as a filter medium that is capable of reducing a large number of active microorganisms from a fluid such as water. The filter medium includes a substrate material. Portions of the substrate material are modified by adhesion of a cationic polymer thereto, the cationic polymer having aluminum-containing groups. The cationically charged material can further include an antimicrobially active metal complexed with the polymer. Illustrative metals include copper, zinc, tin, and preferably silver.

### Detailed Description of the Invention

### Field of the Invention

The present invention relates to filtration materials, and more particularly, this invention relates to a filter medium having enhanced microorganism-reducing properties.

### Description of the Related Art

The use of home water treatment systems to treat tap water continues to grow dramatically in the U.S. and abroad, in part because of heightened public awareness of the health concerns associated with the consumption of untreated tap water. Of particular concern are pathogens, which are microbes that cause disease. They include a few types of bacteria, viruses, protozoa, and other organisms. Some pathogens are often found in water, frequently as a result of fecal matter from sewage discharges, leaking septic tanks, and runoff from animal feedlots into bodies of water from which drinking water is taken. Bio-terrorism also poses a significant threat to water supplies.

Total coliforms are a group of closely related bacteria that live in soil and water as well as the gut of animals. The extent to which total coliforms are present in the source water can indicate the general quality of that water and the likelihood that the water is fecally contaminated. Specific types of coliforms (i.e., fecal coliforms or E. coli) can present serious health risks. The Environmental Protection Agency (EPA) has set forth minimum standards for acceptance of a device proposed for use as a microbiological water purifier. Devices that claim removal of coliforms, represented by the bacteria E. coli and Klebsiella Terregina, must show a minimum 6-log reduction, 99.9999% of organisms removed, from an influent concentration of 1x10⁷/100 ml.

Cryptosporidium is a single-celled microbe contained in a group generally known as protozoa. Cryptosporidium may cause a disease, cryptosporidiosis, when ingested. Cryptosporidiosis symptoms can range from mild stomach upset to life threatening disease in those who are immunocompromised (e.g., people with severely compromised immune systems). Oocysts are a stage in the life-cycle of some Cryptosporidium. In this stage, the Cryptosporidium can infect humans and other animals. The EPA requires removal of at least 99% of Cryptosporidium from water for qualified devices.

Giardia lamblia (commonly referred to as Giardia) are single-celled microbes contained in a group known as protozoa. When ingested, they can cause a gastrointestinal disease called giardiasis. Giardiasis is a frequent cause of diarrhea. Symptoms may include diarrhea, fatigue, and cramps. Waterborne giardiasis may occur as a result of disinfection problems or inadequate filtration procedures. Cysts are a stage in the life-cycle of some Giardia. In this stage, the Giardia can infect humans and other animals. Devices that claim cyst removal must show a minimum 3 log reduction, 99.9% of cysts removed, from an influent concentration of 1x10⁷/L.

Viruses, including hepatitis A virus, rotaviruses, and Norwalk and other caliciviruses, are microbes that can cause serious illness. The EPA requires water purifiers claiming antiviral properties to ensure a 4 log reduction, 99.99% of viruses removed, from an influent concentration of 1x10⁷/L.

Several types of systems exist for the filtration of tap water. One type is a pressurized system, such as a faucet-mount system, and typically uses a porous carbon block as part of the filtration system. The other type is a low pressure system, such as a pitcher filter system, and typically uses activated carbon granules as part on the filtration system. However, few filtration materials are able to meet EPA standards for more than a few liters of water with filters of a reasonable size.

Other systems add particles of inorganic compounds (e.g., magnesium oxides and hydroxides, aluminum oxides) to the filter medium. Such materials have been found to remove microbes very well by trapping the microbes. However, this approach requires that additional material be added to the filter along with the carbon and optional binder, thereby reducing the amount of activated carbon present in the filter. Thus, the life of the filter is shortened.

International Patent Application WO 02/076577 to Hughes broadly describes the use of magnesium compounds in carbon block form to remove microorganisms from a fluid. The purification material disclosed in Application WO 02/076577 removes microorganisms from fluids through adsorption to the magnesium compound. However, because the magnesium containing material only represents a small percentage of the surface area exposed to the fluid, the sites to which microorganisms can become adsorbed are few. Thus, the efficiency of the filter is limited, in that many microorganisms are not captured but merely pass through the filter. In addition, the adsorption sites quickly fill up, making adsorption difficult if not impossible and/or resulting in clogging of the filter pores ultimately resulting in a short filter life. For example, Application WO 02/076577 only discloses the ability to remove microorganisms from 500 ml of water. Moreover, the filter disclosed in Application WO 02/076577 is very large, with an outer diameter of 2.5 inches, an inner diameter of 1.25 inches, and length of 9.8 inches, making it unsuitable for many point-of-use purposes and in portable devices.

United States Patent Nos. 4,753,728 and 5,017,318 to Vanderbilt et al. describe a filter constructed of powdered activated carbon bound by an ultra high molecular weight polyethylene binder, but which is only capable of capturing insignificant quantities of microorganisms.

United States Patent Application No. US 2003/0038084 to Mitchell et al. describes a filter composed of carbon particles heated in an oven in an atmosphere of ammonia that purportedly removes microorganisms through a combination of capturing fimbriae and surface polymers of the microorganisms in pores on the surface of the particular carbon particle, by adsorption and size exclusion.

Some prior art filters use biocidal resins and peroxides to kill microorganisms. For example, United States Patent No. 4,361,486 to Hou and Webster describes the use of magnesium peroxide to oxidize soluble iron and inactivate microorganisms. A drawback to such filters is that the biocidal agent as well as the dead microorganisms pass through the filter and into the drinking water.

U.S. Patent No. 6,565,749 to Hou et al. describes cationic polyamine polymers attached to substrates, including carbon blocks, for removing microorganisms.

United States Patent No. 6,660,172 to Koslow uses a polymer having positively charged quaternary ammonia (quat) groups, with a chlorine or bromine counter ion, these quat groups each having a long alkyl chain (~C18). Quat groups, being positively charged, attract to the negative surface charge of the cell membrane of the bacteria or virus. The long alkyl chain of the quat group penetrates into the cell membrane of the bacteria or virus, causing it to rupture and thereby killing the microorganism. Koslow further performs an ion exchange to complex silver with the polymer. Silver is a known biocide, which affects the respiration of the microbe cell. It is not completely understood how the silver is attached to the polymer. Silver is positively charged, so will not act as a counterion to the nitrogen, but silver and chlorine form silver chloride, which is insoluble in water. Thus, it is believed that the nitrogen-chlorine-silver form a three-way complex in such a ways that the silver does not leach off of the particle.

One problem with this approach is that the solubility of the polymer is largely determined by the number of quaternary ammonium groups present. The more charged it is, the more soluble it will be. However, a point is reached where there are too many quat groups present, making the polymer so soluble it will wash off of the carbon. Thus, very tight control of the polymeric structure must be maintained.

Basic aluminum chloride is a non-polymerated form of the Al₂O₃ and has been used to coat colloidal silica particles to produce a cationically charged colloidal silica (U.S. Patent Nos. 3620978, 3719607, 3745126 and 3956171). Such a product is sold by Eka Chemicals under the trade name BINDZIL and is available in a variety of particle sizes and pH ranges. This material has a high capacity for MS-2 reduction. Although the cost of the aluminum chlorides is low, the high cost of colloidal silica makes it prohibitive for use in consumer products.

What is needed is a more efficient filter medium capable of removing microorganisms to EPA standards from substantially larger quantities of water per unit filter medium than was heretofore possible.

There is also a need for an in-situ biocide in combination with a positive surface charge so as to attract microbes to the surface to which the biocide is attached.

What is further needed is a way to maximize the amount of carbon available to remove contaminants such as chlorine.

What is still further needed is a way to achieve adequate microbial reduction from a filter medium created from only modified activated carbon and binder.

What is even further needed is a way to modify activated carbon such that it has a more positive surface charge for improving the attraction of microbes thereto.

### Summary of the Invention

The present invention solves the problems described above by providing a cationically charged material suitable for use as a filter medium that is capable of reducing a large number of active microorganisms from a fluid such as water. The filter medium includes a substrate material. Portions of the substrate material are modified by adhesion of a cationic polymer thereto, the cationic polymer having aluminum-containing groups. This allows the filter to be created from only the modified activated carbon and binder. The resulting filter medium is very effective at reducing the number of active microorganisms from large quantities of water, in filters small enough for point-of-use systems.

In a preferred embodiment, the substrate material is activated carbon (e.g., granular activated carbon (GAC), powdered activated carbon, bound carbon, composites, agglomerates, etc.), the cationic polymer being adhered to the activated carbon. In another embodiment, the substrate to which the aluminum-containing polymer is adhered is a nonwoven. In a further embodiment, the substrate is a hollow fiber. In yet another embodiment, the substrate is a ceramic.

The cationic polymer is preferably an inorganic polymer. In one embodiment the cationic polymer has aluminum oxide groups. For example, the polymer can be a polyaluminum chloride or a polyaluminum hydroxychloride.

The cationically charged material can further include an antimicrobially active metal complexed with the polymer. Illustrative metals include copper, zinc, tin, and preferably silver.

A filter medium including the cationically charged material can be shaped into any desired form, such as in the form of a block or sheet. For example, the filter medium can be cylindrically shaped with an outer diameter of less than about 4 inches and a maximum length between ends of the filter medium of less than about 3 inches.

The filter medium can be formed by mixing particles of modified activated carbon and the binder. The mixture is heated such that the binder becomes tacky without becoming sufficiently liquid to substantially wet the particles of modified activated carbon. The heated mixture is compressed to control the size of the pores formed by the particles and binder to a mean pore size of between about 0.01 micron and about 10 microns, preferably between about 0.05 and about 5 microns, and ideally between about 0.1 and about 1 microns.

The filter medium is adaptable for use in a filtration device having a housing. The filtration device may be of the type adapted to be mounted to a water source, a pitcher, a bottle, etc. A pump can be coupled to the housing for controlling the flow of the fluid through the filter medium.

A method for forming a cationically charged material includes washing a substrate with a solution containing an aluminum-containing polymer, draining the solution from the substrate, and drying the substrate having the aluminum-containing polymer thereon. The substrate having the aluminum-containing polymer thereon can further be washed in a solution of silver nitrate for complexing silver with the polymer.

The embodiments described herein have particular applicability for countering bioterrorism, by enabling reduction of potentially life-threatening microbials introduced into a water supply by an act of terrorism.

Other aspects and advantages of the present invention will become apparent from the following detailed description, which, when taken in conjunction with the drawings, illustrate by way of example the principles of the invention.

### Brief Description of the Drawings

For a fuller understanding of the nature and advantages of the present invention, as well as the preferred mode of use, reference should be made to the following detailed description read in conjunction with the accompanying drawings.

Figure 1 illustrates a block of the filter medium in cylindrical form.

Figure 2 illustrates the filter medium in the form of a sheet.

### Best Modes for Carrying Out the Invention

The following description includes the best embodiments presently contemplated for carrying out the present invention. This description is made for the purpose of illustrating the general principles of the present invention and is not meant to limit the inventive concepts claimed herein.

The present invention provides a cationically charged material particularly useful in a filter medium capable of reducing and even removing active microorganisms (bacteria, viruses, cysts, etc.) from large quantities of water, and in compliance with the EPA standards mentioned above.

The cationically charged material includes a substrate. The substrate is modified by adhesion of a cationic polymer thereto, the cationic polymer having aluminum-containing groups. The cationic charge of the material attracts the negatively charged microbes to the surface of the material, trapping them on the surface. The cationically charged material preferably includes an antimicrobially active metal complexed with the polymer. For instance, a silver halide complexed with the polymer provides a silver-treated article with a trap and kill mechanism for reduction of active (live) microorganisms.

A preferred substrate material is particulate activated carbon (e.g., granular activated carbon (GAC), powdered activated carbon, bound carbon, composites, agglomerates, etc.), the cationic polymer being adhered to the activated carbon.

Other suitable substrates include fibers forming woven or nonwoven fabrics, hollow fibers, hollow or porous particles, ceramics, etc.

Preferred cationic polymers having aluminum-containing groups are inorganic polymers with aluminum oxide groups and a chlorine or bromine counter ion. The aluminum groups are positively charged, while the counterions are negatively charged.

Illustrative cationic polymers having aluminum oxide groups are polyaluminum chlorides (PACs) such as polyaluminum hydroxychloride (PAH) and polyaluminum chloride and each may be used. PACs are high molecular weight inorganic polymers containing repeating units of aluminum oxide (Al₂O₃), characterized by their strength (usually in % alumina) and basicity (amount of polynuclear material). The basicity refers to the degree of acid neutralization and also represents a measure of how highly polymerized the aluminum is. Although a solution with 0% basicity is an aluminum chloride solution (ACS) and is not considered a PAC, its use should not be precluded from this invention. The lowest basicity of commercially available PAC is about 10%, while most PACs are in the range of 50-70%. One form of PAC, commercially known as Aluminum Chlorhydrate (ACH), has a high alumina content (23%) and basicity (86%). Other PACs have an alumina content of 10-12% Al2O3, in solution. In the dried form the alumina content can be as high has 60%. These materials are not typically characterized by molecular weight.

PAC has the general formula Al₁₃(OH)₂₀(SO₄)₂.Cl₁₅. A general formula for ACS is Al₂Cl(OH)₅. The repeating units are Al₂O₃.

These highly polymerized aluminum species have a cationic charge density higher than that of standard aluminum chloride and organic quaternary ammonium or amine polymers. Because of the higher charge density, the material is more effective at attracting microbes.

One suitable PAC is sold under the trade name DELPAC by Delta Chemical Corporation, 2601 Cannery Avenue, Baltimore, Maryland 21226-1595. Another manufacturer of PAC is Holland Company, 153 Howland Avenue, Adams, Massachusetts 01220-1199. PAH is available under the trade name EKOFLOCK from Eka Chemicals Inc., 204 Spring Hill Rd., Trumbull, CT 06611. PAC and PAH can be obtained in solution, or in powdered form.

PAH and PAC in neat form have been used as a coagulant in potable water treatment facilities and industry for the removal of sediment, color, total organic carbon (TOC), phosphorus, heavy metals and microorganisms. The ability of the PAH and PAC to reduce the turbidity of untreated water by agglomeration of smaller particles into larger particles can also be used to agglomerate smaller carbon particles (e.g., <50 micron mean particle diameter) into larger carbon granules coated with the polyaluminum material. This granular material could then be used in pour through applications as a loose bed, sheet or block of granules without the need for ion exchange resins due to the ability of the PAH and PAC to remove heavy metals such as lead without affecting the pH of the water. By loose bed, what is meant is that no binder is present. In pressurized systems, the treated carbon can be used to replace conventional lead adsorbents. To reduce cost, treated carbons can be mixed with untreated carbon in varying ratios to obtain the necessary levels for particular contaminant removal.

Materials treated with cationic aluminum-containing polymers containing halides, such as chlorine and bromine, can be treated with a solution of an antimicrobially active metal including but not limited to silver, copper, tin and zinc. For example, the cationically charged material can be treated with silver nitrate to drive the formation of an insoluble, antimicrobially active silver-halide complex in direct proximity to the cationic material. This produces a silver-treated article with a trap and kill mechanism for reduction of the number of live microorganisms.

Methods for treatment of a substrate (e.g., activated carbon) with polyaluminum chlorides can include methodologies similar to the patents for production of cationically charged silica. However, polyaluminum materials are used as the source of Al₂O₃ as opposed to basic aluminum chloride and carbon or polymeric fibers are used as the substrate as opposed to silica.

The solubility of polyaluminum chlorides (e.g., PAC and PAH) is pH mediated, and is more soluble in acidic conditions (pH = ~2-3). Thus, an acidic solution of PAC is added to the substrate to coat the substrate with PAC. The substrate is then drained and dried. Some of the polyaluminum chloride will remain on the substrate, imparting a cationic surface charge on the now-modified substrate.

Activated carbon tends to have oxygen groups, sulfonate groups, carbonate groups, nitrate groups, etc. on the surface thereof, as a byproduct to the activation process (which involves application of acids to the carbon). These give the carbon particles a negative surface charge. A typical Zeta potential of activated carbon is about -40 mV. The positively charged PAC is attracted to the negative surface of the activated carbon. Also, because the polymer is long, the polymeric chains bind up the carbon in solution. When the carbon is drained and dried, it is covered by the polymer.

While not wishing to be bound by any particular theory, it is believed that the PAC adheres to the activated carbon by combination of van der Waals forces and bonding between the aluminum and the oxygen atoms already coupled to the surface of the activated carbon. The aluminum can bond with several different oxygen atoms.

After draining and drying the modified substrate with polymer, the modified substrate with polymer are washed with a silver nitrate (AgNO₃) solution followed by filtration and drying, resulting in a cationically charged material that has an Al-Cl-Ag complex in proximity to its outer surface.

The resultant material is a cationically charged material having an overall positive (cationic) surface charge. The cationically charged material can then be used as is in pour-through filtration applications. The cationically charged material can also be ground, mixed with a binder, and heated to form a porous filter block for pressurized filtration systems. This general process allows a filter to be created from only the modified cationically charged material and binder. The resulting filter medium is very effective at reducing the number of active microorganisms in large quantities of water, in filters small enough for point-of-use systems.

Most microorganisms of concern have a negative surface charge. For example, most types of bacteria have a membrane layer of phospholipids that give the bacteria a negative charge. When negatively charged viruses and bacteria pass through the pores of the filter medium, they are attracted to the positively charged surface of the filter medium and become adsorbed to the surface by electrostatic interactions. Because most, if not all, of the surfaces of the pores themselves become charged, the filter medium has more charged sites with which to adsorb microorganisms, as well as an overall increase in electrostatic forces. The silver acts as a biocide to kill the microbes. As the microbe cell breaks down, it would return to the water, freeing the site for continued antimicrobial activity. Thus, the filter medium is able to remove substantially more active microorganisms per unit weight of filter medium and/or per unit volume of filter medium than was heretofore possible.

Cationically charged materials containing PAH and PAC have also been found to provide excellent removal of sediment, color, polyanionic organics (e.g., tannic acid, phobic acid, total organic carbons (TOC), etc.), phosphorus, and heavy metals (e.g., lead, cadmium, etc.). Thus, a cationically charged material having an activated carbon substrate is a carbon product that removes active microbes, heavy metals, and organics, along with the contaminants typically removed by activated carbon (e.g., chlorine). The ability of the PAH to remove TOC may also aid in the microorganism removal without the need for a prefilter for TOC removal.

A preferred method of making a block-type filter is by mixing, heating, and compressing particles of cationically charged material (e.g., modified activated carbon) and particles of binder in a mold of the desired shape to encourage binding and to adjust the pore size. A preferred range of compression is between about 1 percent to about 30 percent reduction of the volume of the mixture. This method is described in more particularity in the EXAMPLES section below, but is presented briefly here to provide a context for the following description.

The pore size of the filter medium is important, as it is desirable to place the microorganism in close proximity to the adsorbent surface of the filter medium. In general, the smaller the pore size, the more readily the microorganisms become adsorbed to the surface of the filter medium. This is because as pore size decreases, the microorganisms come into closer proximity to the adsorptive surface as they pass with the fluid through the pores of the filter medium. The pore size is preferably small enough to physically filter out more oocysts (e.g., cryptosporidium) and cysts (e.g., Giardia muris and Giardia lamblia) than required by the EPA standards discussed above, though the silver would function to kill such larger microorganisms in filters with larger pore sizes. A preferred range of mean pore sizes is 0.01 to 10 microns. More preferably, the mean pore size of the filter medium is within the range 0.1 to 1 microns.

The term “low melt index binder” preferably refers to binders that have very low to virtually no melt index (melt flow rate), meaning that when heated the binders will become tacky at elevated temperatures without becoming sufficiently liquid to significantly wet the surfaces of the carbon particles and the particles of inorganic material, i.e., will not flow. The use of a low melt index binder in the present invention maximizes the effectiveness of the cationically charged material. Because the binder becomes tacky rather than fluid, the cationically charged material adheres to the surface of the binder rather than becoming encased in the binder during formation of the filter medium into its final shape. This maximizes the exposed surface area of the cationically charged material, and thus its effectiveness.

The melt flow rate or melt index is determined by ASTM D1238 or DIN 53735 at 190 degrees C. and 15 kilograms. The amount of material that flows through the die should be less than about 1 gram/10 minutes, more preferably less than 0.5 grams/10 minutes and ideally less than 0.1 gram/10 minutes. The most preferred binder is an ultra high molecular weight, high density polyethylene. The high molecular weight gives rise to the restricted flow properties of the melted material which is so important to this aspect of the invention. The following table shows a comparison of selected properties of the ultra high molecular weight, high density polyethylene with other types of polyethylene binders. Table 1 – Binders for carbon blocks

TABLE 1
Binders for carbon blocks

| | Melt Temp. (° C.) | Melt index^{± (° C.)} |
|---|---|---|
| LDPE^{a} | 102-110 | 5-70 |
| HDPE^{b} | 134 | 10.5 |
| VHMWPE^{c} | 135 | 1.8 |
| UHMWPE^{d} | 135 | <0.1 |

One ultra high molecular weight, high density polyethylene has a density of 0.935 grams per cubic centimeter and a melt index of less than 0.1 grams per ten minutes as determined by DIN 53735 at 190/15. It has a vicat softening point of approximately 74 degrees centigrade and a crystalline melting range of 135 to 138 degrees C. (The Vicat softening point, measured by ASTM D 1525 (ISO 306) procedures, is the temperature at which a flattened needle of 1 mm² cross section, and under a specified constant load, penetrates a specimen of the plastic to a depth of 1 mm. It is useful as a rough comparative guide to a resin's resistance to elevated temperatures.) Such polyethylenes have a molecular weight higher than 4 million, and typically from about 4 to about 6 million.

The temperature at which the most preferred binder becomes sufficiently tacky to adhere to the carbon particles may vary depending on the specific polymer used. With the high molecular weight, high density polyethylene, the binder and carbon particles can be processed at a temperature of from about 175 degrees C. to about 205 degrees C. for about 2 hours.

The percentage of binder used to bind the cationically charged material is preferably in the range of about 10 to about 40 weight percent, more preferably in the range of about 20 to about 35 weight percent, and most preferably about 25 to about 30 percent by weight based on the total weight of the filter medium. These ranges provide enough binder to hold the particles of cationically charged material together, while not blocking the surface pores of the cationically charged material.

The binder is preferably utilized in particulate or powder form so that it can be uniformly mixed and dispersed with the cationically charged material. The use of the preferred polymer binders allows one to bind the particles of cationically charged material together without excessively wetting the particles when melted and thereby effectively occluding much of the surface area of the cationically charged material.

A preferred mean particle size of the binder is in the range from about 120 microns to about 140 microns. Note, however, that the mean particle size of the binder used is not critical and can be made larger or smaller based on the desired properties of the filter medium. For example, smaller particle size can be used to make the pore size smaller with a resultant increase in contaminants captured and reduction in flow rate.

The preferred cationically charged material includes a carbon substrate. The preferred carbon is powdered activated carbon with a mean particle size (outer diameter) in the range of about 20 to about 120 microns, and ideally in the range of about 90 to about 110 microns, and most ideally at about 100 microns. Note, however, that the mean particle size of the carbon used is not critical and can be made larger or smaller based on the desired properties of the filter medium. For example, smaller particle size carbon can be used to make the pore size smaller with a resultant increase in contaminants captured and reduction in flow rate. Particularly, a filter medium formed from smaller modified carbon particles have a larger surface area, resulting in greater contact time and thus greater performance.

The percentage of cationically charged material in the filter medium is preferably in the range of about 60 to about 90 weight percent, and more preferably in the range of about 70 to about 80 weight percent by weight based on the total weight of the filter medium.

The filter medium can be created in virtually any desired shape. Figure 1 illustrates a block 100 of the filter medium in cylindrical form, and which is particularly adapted to faucet mount systems such as the system found in U.S. Patent No. 6,123,837 to Wadsworth et al. and to pitcher systems such as the system found in U.S. Patent No. Des. 398,184 to Silverberg et al., each of which are herein incorporated by reference. A standard-sized cylindrical filter block for point-of-use systems is about 4 inches in length or less between the ends 102, 104 of the block 100, and has an outer diameter (OD) of less than about 4 inches and an inner diameter (ID) of less than about one inch. A preferred embodiment is less than about 3 inches in length and has an outer diameter of less than about 2.5 inches and an inner diameter of less than about 0.5 inch.

Figure 2 illustrates the filter medium in the form of a sheet 200 formed by a nonwoven mesh of cationically charged material. The sheet 200 can then be placed in a housing and a fluid such as water passed therethrough. Such a sheet 200 can also be used as a prefilter or wrap for a primary granular, block type, or sheet filter.

A prefilter can be added to extend the life of the filter. For example, a prefilter of nonwoven material can be used to remove larger contaminants, sediment, etc. A prefilter of hollow fibers can also be used to filter out larger microbes (bacteria). A prefilter including cationically charged material (e.g., carbon with PAC or PAH thereon (with or without Ag)) can be used to remove organics such as TOCs so that the TOCs don’t bind up or block the carbon sites that would otherwise be available to capture microbes. The prefilter preferably has a larger pore size than the main filter element to avoid blockage.

The filter medium can be used in a wide variety of applications. As mentioned above, one use to which it is particularly adaptable is for pressurized and gravity-flow applications such as faucet-mount filters and pitcher filters. Other applications are use in granular filters, high volume “under-the-sink” or commercial-type filters, and refrigerator filters.

The filter medium can also be made for/used in portable applications, such as for use in filters for camping, bottles with filters, emergency kits, etc. The filter medium is also useful in med-evac systems, allowing filtration of water in the field to rehydrate soldiers. In portable uses, the filter medium can be formed in a block smaller than the cylindrical block disclosed above for 5, 15, 30 gallons, etc.

The filter medium would also be particularly effective at purifying water contaminated by an act of bio-terrorism. For example, the faucet-mount system could allow users to continue to use a contaminated public water supply until fresh water were made available. Similarly, portable versions (pitchers, bottles, bags, etc. with the filter medium attached) can be stored in homes and businesses, stored in emergency kits, carried in automobiles, etc. Further, such portable versions can be made available and/or distributed to people rather quickly in response to a bio-terrorism attack.

A hand-pump, foot-pump, battery-pump, solar-powered pump, etc. may be coupled to any of the embodiments described herein to pressurize the influent water and/or reduce pressure in the effluent stream to draw water through the filter medium.

### Example 1

Following is an example of a preferred procedure for creating a cationically charged material. Activated carbon particles are mixed in a solution of 3% PAH in deionized water followed by filtration. The carbon is then washed with a 0.5 molar silver nitrate solution followed by filtration and drying. The agglomerated carbon can then be used as is in pour-through filtration applications. The agglomerated carbon can also be ground, mixed with a binder, and heated to form a porous filter block for pressurized filtration systems.

### Example 2

Following is an example of a preferred procedure for creating a cationically charged material. A nonwoven mesh of polymeric fibers is immersed in a solution of 3% PAC in deionized water followed by removal of the nonwoven mesh from the solution. The nonwoven mesh is then washed with a 0.5 molar silver nitrate solution followed by filtration and drying.

### Example 3

Following is an example of a preferred procedure for creating a cationically charged material. A bundle of hollow fibers is immersed in a solution of 3% PAH in deionized water followed by removal of the bundle from the solution. The bundle is then washed with a 0.5 molar silver nitrate solution followed by filtration and drying.

### Example 4

Following is an example of a preferred procedure for forming a porous block of filter medium. Modified granular activated carbon with a mean particle size (outer diameter) of about 100 microns is mixed with particles of an ultra high molecular weight polyethylene binder (and/or other binder) having a mean particle size in the range of about 120 to 140 microns, a melt index of less than 1, and a melting temperature of about 135° C. The modified carbon is present at between about 50-80% by weight of the filter medium. The mixture of modified carbon and binder are thoroughly mixed in a blender or other suitable mixing device for a period of time sufficient to create a substantially uniform dispersion of materials in the mixture.

The blended mixture is heated and compressed in a stainless steel mold having the desired shape. The material in the mold is heated in an oven to about 473 degrees F (245° C.) for about 40 minutes. The heating makes the binder sticky so that it binds the modified carbon particles into a porous block. The compression is used to urge binding as well as to control the pore size.

Formation of the filter medium by extrusion is also possible.

### Example 5

Following is an example of a procedure for forming a porous block of filter medium. Modified granular activated carbon and unmodified granular activated carbon particles with a mean particle size (outer diameter) of about 100 microns are mixed with particles of an ultra high molecular weight polyethylene binder (and/or other binder) having a mean particle size in the range of about 120 to 140 microns, a melt index of less than 1, and a melting temperature of about 135° C. The modified carbon is present at between about 50-80% by weight of the filter medium. The mixture of modified carbon, unmodified carbon, and binder are thoroughly mixed in a blender or other suitable mixing device for a period of time sufficient to create a substantially uniform dispersion of materials in the mixture.

The blended mixture is heated and compressed in a stainless steel mold having the desired shape. The material in the mold is heated in an oven to about 473 degrees F (245° C.) for about 40 minutes. The heating makes the binder sticky so that it binds the modified carbon particles into a porous block. The material is then compressed in the mold. The compression is used to urge binding as well as to control the pore size.

### Example 6

Following is an example of a procedure for forming a porous cylindrically-shaped block of filter medium. Particles of modified activated carbon and binder are blended into a mixture. The modified carbon is present at between about 50-80% by weight of the filter medium. The blended mixture is then placed in a stainless steel mold having the desired shape. In this example, the desired shape is cylindrical, so the mold is a tube with a rod protruding along its centerline. The material in the mold is heated in an oven to about 473 degrees F (245° C.) for about 40 minutes. The material is then compressed in the mold using a ring-shaped compression member.

The ends of the block can be capped using any suitable adhesive, such as polymeric glue. The block can then be placed in a housing that directs influent water to an outer periphery of the block so that the water passes through the block into the center chamber of the block and is then expelled through one of the end caps as filtered water. Note that the flow through the filter may also be reversed.

As described herein, filter media constructed with the cationically charged material meet EPA standards for viruses and coliforms. In fact, the filter medium can achieve near 100% microorganism removal at over 120 gallons. Particularly, 75 grams of the filter media described in the examples provides a greater than 4 log reduction (99.99%) of viruses, represented by MS-2, from an influent concentration of 1x10⁷ PFU/L (where PFU = Plaque Forming Units), for 120 gallons at a flow rate of 0.5-0.75 gal/min at an influent pressure range of about 50-70 psi when in the form of a carbon block. The filter media described in the examples provides a greater than 6 log reduction (99.9999%) of coliforms, represented by the bacteria E. coli and Klebsiella Terregina, from an influent concentration of 1x10⁷/100mL, for 120 gallons at a flow rate of about 0.5-0.75 gal/min at an influent pressure range of 50-70 psi.

In a gravity flow system, the filter media described in the examples provides a greater than 4 log reduction (99.99%) of viruses, from an influent concentration of 1x10⁷/L, for 120 gallons. The filter media described in the examples also provides a greater than 6 log reduction (99.9999%) of coliforms, represented by the bacteria E. coli and Klebsiella Terregina, from an influent concentration of 1x10⁷/100mL, for 120 gallons in a gravity flow system. These experiments used 75 grams of granular cationically charged material in a loose bed.

In comparative experimentation, the filter disclosed in International Patent Application WO 02/076577 to Hughes was only effective up to about 1.33 gallons; at 30 gallons, very poor results were obtained. Thus, the virus-reducing properties of the filter medium disclosed herein can process nearly 100 times the volume, and thus may have almost 100 times the life, as other systems.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A cationically charged material, comprising: a substrate having a cationic polymer coupled thereto, the cationic polymer having aluminum-containing groups.

2. A cationically charged material as recited in claim 1, wherein the substrate is activated carbon.

3. A cationically charged material as recited in claim 1, wherein the substrate is selected from a group consisting of woven fibers, nonwoven fibers, hollow fibers, activated carbon, and a ceramic.

4. A cationically charged material as recited in claim 1, wherein the cationic polymer is an inorganic polymer.

5. A cationically charged material as recited in claim 1, wherein the cationic polymer has aluminum oxide groups.

6. A cationically charged material as recited in claim 1, wherein the cationic polymer is a polyaluminum chloride.

7. A cationically charged material as recited in claim 1, wherein the cationic polymer is a polyaluminum hydroxychloride.

8. A cationically charged material as recited in claim 7, wherein the polyaluminum hydroxychloride is an aluminum chlorohydrate.

9. A cationically charged material as recited in claim 1, further comprising an antimicrobially active metal complexed with the polymer.

10. A cationically charged material as recited in claim 9, wherein the metal is selected from a group consisting of copper, zinc, tin, and silver.

11. A cationically charged material as recited in claim 9, wherein the metal is silver.

12. A cationically charged material as recited in claim 9, wherein 75 grams of the cationically charged material performs a greater than 1 x 10⁴ plaque forming units/milliliter reduction of viruses after 120 gallons of water passes through the filter medium.

13. A filter medium, comprising: a cationically charged material having a substrate with a cationic polymer coupled thereto, the cationic polymer having aluminum-containing groups, the cationically charged material being arranged in a porous array such that a fluid is passable through pores of the array.

14. A filter medium as recited in claim 13, wherein the substrate is activated carbon.

15. A filter medium as recited in claim 13, wherein the substrate is selected from a group consisting of woven fibers, nonwoven fibers, hollow fibers, activated carbon, and a ceramic.

16. A filter medium as recited in claim 13, wherein the cationic polymer is an inorganic polymer.

17. A filter medium as recited in claim 13, wherein the cationic polymer has aluminum oxide groups.

18. A filter medium as recited in claim 13, wherein the cationic polymer is a polyaluminum chloride.

19. A filter medium as recited in claim 13, wherein the cationic polymer is a polyaluminum hydroxychloride.

20. A filter medium as recited in claim 19, wherein the polyaluminum hydroxychloride is an aluminum chlorohydrate.

21. A filter medium as recited in claim 13, further comprising an antimicrobially active metal complexed with the polymer.

22. A filter medium as recited in claim 21, wherein the metal is selected from a group consisting of copper, zinc, tin, and silver.

23. A filter medium as recited in claim 21, wherein the metal is silver.

24. A filter medium as recited in claim 13, wherein the cationically charged material is arranged in a loose bed.

25. A filter medium as recited in claim 24, wherein 75 grams of the filter medium performs a greater than 1 x 10⁴ plaque forming units/milliliter reduction of viruses after 120 gallons of water passes through the filter medium under the force of gravity.

26. A filter medium as recited in claim 13, further comprising a binder, the cationically charged material and binder being formed into a porous filter block.

27. A filter medium as recited in claim 26, wherein 75 grams of the filter medium performs a greater than 1 x 10⁴ plaque forming units/milliliter reduction of viruses after 120 gallons of water passes through the filter medium at a flow rate of about 0.5 to about 0.75 gallons per minute at an influent pressure of about 50 to about 70 psi.

28. A filter medium as recited in claim 26 wherein the filter medium is cylindrically shaped with an outer diameter of less than about 4 inches and a maximum length between ends of the filter medium of less than about 3 inches.

29. A filter medium as recited in claim 26, wherein a mean pore size of pores formed by the cationically charged material and binder is between about 0.01 micron and about 10 microns.

30. A filter medium as recited in claim 26, wherein a mean pore size of pores formed by the particles and binder is between about 0.1 micron and about 1 microns.

31. A filter medium as recited in claim 13, further comprising a prefilter.

32. A filter medium as recited in claim 31, wherein the prefilter includes a cationically charged material.

33. A filter medium as recited in claim 13, wherein the filter medium is formed in a sheet.

34. A filter medium as recited in claim 13, wherein the fluid is water.

35. A method for reducing a number of active microorganisms in a fluid, comprising causing the fluid to flow through the filter medium of claim 13.

36. A device for reducing a number of active microorganisms in a fluid, comprisinga housing; andthe filter medium of claim 13 positioned in the housing.

37. A device as recited in claim 36, wherein the housing is adapted to be mounted to a pressurized water source.

38. A device as recited in claim 36, wherein the housing is a pitcher.

39. A device as recited in claim 36, wherein the housing is a bottle.

40. A device as recited in claim 36, further comprising a pump coupled to the housing for urging flow of the fluid through the filter medium.

41. A filter medium, comprising: a cationically charged material, comprising: activated carbon particles; a cationic polymer coupled to the activated carbon particles, the cationic polymer having aluminum-containing groups; and an antimicrobially active metal complexed with the polymer; and a binder coupling the cationically charged material in a porous block form.

42. A filter medium as recited in claim 41, wherein the cationic polymer has aluminum oxide groups.

43. A filter medium as recited in claim 41, wherein the cationic polymer is a polyaluminum chloride.

44. A filter medium as recited in claim 41, wherein the cationic polymer is a polyaluminum hydroxychloride.

45. A filter medium as recited in claim 41, further comprising a prefilter.

46. A filter medium as recited in claim 41, wherein 75 grams of the filter medium performs a greater than 1 x 10⁴ plaque forming units/milliliter reduction of viruses after 120 gallons of water passes through the filter medium at a flow rate of about 0.5 to about 0.75 gallons per minute at an influent pressure of about 50 to about 70 psi.

47. A device for reducing a number of active microorganisms in a fluid, comprising a housing; and the filter medium of claim 41 positioned in the housing.

48. A filter medium, comprising: a cationically charged material, comprising: fibers; a cationic polymer coupled to the fibers, the cationic polymer having aluminum- containing groups; and an antimicrobially active metal complexed with the polymer, the cationically charged material being formed in a porous mesh.

49. A filter medium as recited in claim 48, wherein the cationic polymer has aluminum oxide groups.

50. A filter medium as recited in claim 48, wherein the cationic polymer is a polyaluminum chloride.

51. A filter medium as recited in claim 48, wherein the cationic polymer is a polyaluminum hydroxychloride.

52. A filter medium as recited in claim 48, further comprising a prefilter.

53. A filter medium as recited in claim 48, wherein 75 grams of the filter medium performs a greater than 1 x 10⁴ plaque forming units/milliliter reduction of viruses after 120 gallons of water passes through the filter medium at a flow rate of about 0.5 to about 0.75 gallons per minute at an influent pressure of about 50 to about 70 psi.

54. A device for removing microorganisms from a fluid, comprising a housing; and the filter medium of claim 48 positioned in the housing.

55. A filter medium, comprising: a cationically charged material, comprising: hollow fibers; a cationic polymer coupled to the hollow fibers, the cationic polymer having aluminum-containing groups; and an antimicrobially active metal complexed with the polymer, the cationically charged material being formed in a porous mesh.

56. A filter medium as recited in claim 55, wherein the cationic polymer has aluminum oxide groups.

57. A filter medium as recited in claim 55, wherein the cationic polymer is a polyaluminum chloride.

58. A filter medium as recited in claim 55, wherein the cationic polymer is a polyaluminum hydroxychloride.

59. A filter medium as recited in claim 55, further comprising a prefilter.

60. A filter medium as recited in claim 55, wherein 75 grams of the filter medium performs a greater than 1 x 10⁴ plaque forming units/milliliter reduction of viruses after 120 gallons of water passes through the filter medium at a flow rate of about 0.5 to about 0.75 gallons per minute at an influent pressure of about 50 to about 70 psi.

61. A device for removing microorganisms from a fluid, comprisinga housing; andthe filter medium of claim 55 positioned in the housing.

62. A method for forming a cationically charged material, comprising: washing a substrate with a solution containing an aluminum-containing polymer;draining the solution from the substrate; anddrying the substrate having the aluminum-containing polymer thereon.

63. A method as recited in claim 62, further comprising washing the substrate having the aluminum-containing polymer thereon in a solution of silver nitrate for complexing silver with the polymer, draining the solution of silver nitrate from the substrate, and drying the substrate having the aluminum-containing polymer and silver thereon.

64. A method as recited in claim 62, further comprising shaping the mixture in the form of a porous block.

65. A method as recited in claim 62, further comprising shaping the mixture in the form of a sheet.

66. A method as recited in claim 62, wherein the cationic polymer has aluminum oxide groups.

67. A method as recited in claim 62, wherein the cationic polymer is a polyaluminum chloride.

68. A method as recited in claim 62, wherein the cationic polymer is a polyaluminum hydroxychloride.
